(19) United States
(12) Patent Application Publication
(10) Pub. No.: US 2018/0288336 A1
(43) Pub. Date: Oct. 4, 2018

(54) IMAGE PROCESSING APPARATUS

(71) Applicant: CANON KABUSHIKI KAISHA, Tokyo (JP)

(72) Inventor: Hironori Aokage, Plainview, NY (US)

(21) Appl. No.: 15/937,029

(22) Filed: Mar. 27, 2018

(30) Foreign Application Priority Data
Apr. 3, 2017 (JP) 2017-073927

(51) Int. Cl. H04N 5/262; H04N 5/235

(52) U.S. Cl. CPC H04N 5/2621; H04N 5/2355; H04N 5/2624

(57) ABSTRACT

An image processing apparatus which captures a group of combining frames different in exposures and generates one frame by combining frames includes an image capturing unit configured to capture four frames including a proper frame every other frame and an under frame in one frame and an over frame in a remaining one frame therebetween as a combining frame group, a development unit configured to develop each frame in the combining frame group, a combining unit configured to select at least one frame in the combining frame group to combine based on the developed combining frame group, and a processing unit configured to apply an effect based on the combined combining frame.

### BACKGROUND OF THE INVENTION

### Field of the Invention

The present invention relates to image processing for obtaining a moving image in frames subjected to high dynamic range combination from images in a plurality of frames especially in digitalized moving image signals.

### Description of the Related Art

There is a conventional technique of image processing for obtaining a high dynamic range image (hereinbelow, referred to as HDR) by combining images in a plurality of frames which are captured in different exposure amounts. According to the technique, an image without overexposure or underexposure can be obtained by combining signals of proper exposure in each image. According to the technique, the same can be applied to a moving image by repeating combining of a plurality of captured frames into one frame in time series. However, when the technique is applied to a moving image, there is an issue that a frame rate of a combined moving image is generally reduced lower than an image capturing frame rate, and thus a movement of a moving object portion looks unnatural. In contrast, a method for making a movement look natural is known in which a moving object portion is detected, and a multiplex combining unit and the like combines images according to a detected result and adds an effect of giving a blurring appearance to the object.

On the other hand, when an effect is individually applied to each image before combining, the effect can be further greatly exerted. In this case, the effect becomes greater when the number of frames to be captured is larger and an exposure difference is larger. However, when assuming a case in which a moving object is detected in frames having the same exposure, as the number of frames to be captured and the exposure difference are larger, a distance becomes larger between the frames having the same exposure, and accuracy of moving object detection is deteriorated. In addition, when information such as auto focus (AF), auto exposure (AE), and auto white balance (AWB), (hereinbelow, referred to as an auto correction system) is obtained from an image, it is desirable to obtain the information from a properly exposed frame, and correction is performed by applying the information to a frame other than the properly exposed frame. In this case, when a distance is large between the properly exposed frame and the other frame, correction accuracy is deteriorated.

Japanese Patent Application Laid-Open No. 2011-199787 describes a technique in which when one image is generated by combining a plurality of images, the number of combined images is determined based on a noise amount and a required contrast amount.

Japanese Patent Application Laid-Open No. 2006-5681 describes a technique which can store images capturing an object in different exposure times in one moving image data and reproduce the moving image data in a plurality of reproduction modes, and in other words, a technique which can reproduce two types of images having different atmospheres by storing two types of images in one stream and selecting frames when reproducing.

According to the technique described in Japanese Patent Application Laid-Open No. 2011-199787, when combination of moving images is assumed, a frame rate needs to be changed accordingly in a case where the number of combined frames is variable. In addition, when the number of combined images is increased, a temporal distance becomes larger between frames having the same exposure, and accuracy of the moving object detection is significantly deteriorated. Further, when the information of the auto correction system is obtained from a certain frame, a temporal distance becomes larger between the frame from which the information is obtained and a frame to be corrected, and correction accuracy is deteriorated.

According to the technique described in Japanese Patent Application Laid-Open No. 2006-5681, a configuration of an image capturing method is similar to that of HDR in a moving image, however, it is difficult to exert an HDR effect since images are not combined.

In other words, the conventional techniques are not sufficient to exert the HDR effect when increasing the number of combined frames while maintaining accuracy of the moving object detection and correction accuracy of the auto correction system.

### SUMMARY OF THE INVENTION

One exemplary embodiment of the present invention is an image processing apparatus which captures a group of combining frames different in exposures and generates one frame by combining frames and includes an image capturing unit configured to capture four frames including a proper frame every other frame and an under frame in one frame and an over frame in a remaining one frame therebetween as a combining frame group, a development unit configured to develop each frame in the combining frame group, a combining unit configured to select at least one frame in the combining frame group to combine based on the developed combining frame group, and a processing unit configured to apply an effect based on the combined combining frame.

Further features of the present invention will become apparent from the following description of exemplary embodiments with reference to the attached drawings.

### BRIEF DESCRIPTION OF THE DRAWINGS

FIG. 1 is a block diagram illustrating a first exemplary embodiment.

FIG. 2 is a block diagram illustrating an HDR painterly processing unit according to the first exemplary embodiment.

FIG. 3 illustrates an image capturing order according to the first exemplary embodiment.

FIG. 4 is a block diagram illustrating development units according to the first exemplary embodiment.

FIG. 5 illustrates gammas according to the first exemplary embodiment.

FIG. 6 is a block diagram illustrating a combining unit according to the first exemplary embodiment.

FIG. 7 illustrates a luminance composition ratio according to the first exemplary embodiment.

FIG. 8 illustrates a luminance difference composition ratio according to the first exemplary embodiment.

FIG. 9 is a block diagram illustrating a combining unit according to the first exemplary embodiment.

FIG. 10 illustrates a luminance composition ratio according to the first exemplary embodiment.

FIG. 11 illustrates a luminance difference composition ratio according to the first exemplary embodiment.

FIG. 12 illustrates a tone curve according to the first exemplary embodiment.

FIG. 13 is a block diagram illustrating a local contrast correction unit according to the first exemplary embodiment.

FIG. 14 illustrates an area segmentation according to the first exemplary embodiment.

FIG. 15 illustrates a representative value in each area according to the first exemplary embodiment.

FIG. 16 illustrates a gain table according to the first exemplary embodiment.

FIG. 17 is a block diagram illustrating an HDR painterly processing unit according to a second exemplary embodiment.

FIG. 18 is a block diagram illustrating a development unit according to the second exemplary embodiment.

FIG. 19 illustrates a gamma according to the second exemplary embodiment.

FIG. 20 is a block diagram illustrating a combining unit according to the second exemplary embodiment.

FIG. 21 illustrates a luminance composition ratio according to the second exemplary embodiment.

FIG. 22 illustrates a luminance difference composition ratio according to the second exemplary embodiment.

FIG. 23 is a block diagram illustrating a combining unit according to the second exemplary embodiment.

FIG. 24 illustrates a luminance composition ratio according to the second exemplary embodiment.

FIG. 25 illustrates a luminance difference composition ratio according to the second exemplary embodiment.

FIG. 26 illustrates overlap image capturing according to the second exemplary embodiment.

FIG. 27 is a block diagram illustrating a third exemplary embodiment.

FIG. 28 illustrates a storage condition of a memory according to the third exemplary embodiment.

FIG. 29 is a flowchart illustrating the third exemplary embodiment.

FIG. 30 is a flowchart illustrating image processing according to the third exemplary embodiment.

### DESCRIPTION OF THE EMBODIMENTS

Various exemplary embodiments of the present invention will be described below.

According to a first exemplary embodiment, a configuration is described in which a digital camera for capturing a moving image captures four frames including a proper frame, an under frame, a proper frame, and an over frame in time series, performs HDR composition thereon, and applies a painterly effect to the generated HDR image. Each frame is developed using a gamma for matching brightness of the frame with each other. Thus, moving object detection which is essential in a moving image can be performed by calculating a difference value between adjacent frames.

In addition, a method is described which calculates a white balance (WB) coefficient using each proper frame and uses the WB coefficient for WB correction of an under frame and an over frame captured immediately after each proper frame. Further, as an effect to be applied to a moving image, processing (a painterly effect) is described as an example which generates a halo (a white or black halo) at an edge portion having a large density difference in addition to darkening a bright portion and brightening a dark portion by correcting a tone.

As described above, the present exemplary embodiment is directed to compatibility between maintaining of the painterly effect by performing HDR composition using three types of exposures and applying the effect and continuity of the WB correction in a moving image by calculating a WB coefficient using a proper frame to be periodically inserted.

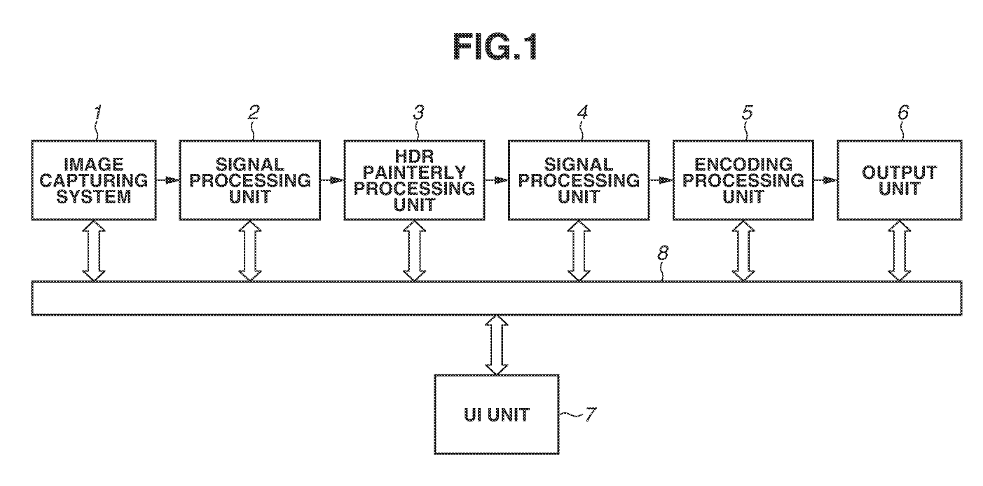

FIG. 1 is a block diagram illustrating an example of a camera system according to the first exemplary embodiment.

The camera system illustrated in FIG. 1 includes an image capturing system 1 as an image capturing unit, a signal processing unit 2, an HDR painterly processing unit 3, a signal processing unit 4, an encoding processing unit 5, an output unit 6, a user interface (UI) unit 7, and a bus 8.

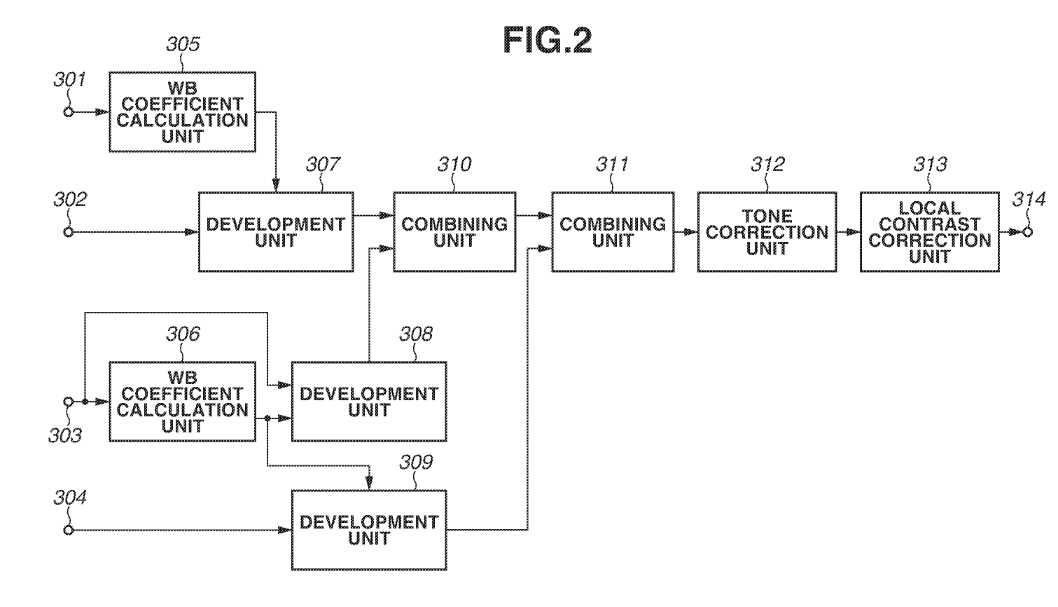

FIG. 2 is a block diagram illustrating an example of the HDR painterly processing unit 3.

The HDR painterly processing unit 3 illustrated in FIG. 2 includes input terminals 301, 302, 303 and 304, WB coefficient calculation units 305 and 306, development units 307, 308 and 309, combining units 310 and 311, a tone correction unit 312, a local contrast correction unit 313, and an output terminal 314.

A processing outline according to the present apparatus including the above-described configuration is described below.

The image capturing system 1 photoelectrically converts light passing through an iris, a lens, and the like by an imaging element including a complementary metal-oxide semiconductor (CMOS) and a charge-coupled d (CCD) and supplies the photoelectrically converted image data to the signal processing unit 2. The imaging element includes a Bayer array. The signal processing unit 2 performs analog-to-digital (A/D) conversion, gain control, and the like on the photoelectrically converted image data and supplies the processing result to the HDR painterly processing unit 3 as a digital image signal. The UI unit 7 performs imaging settings such as selection of moving image/still image modes, an HDR painterly mode, an ISO sensitivity, and a shutter speed, and information of these settings is supplied to the image capturing system 1, the signal processing unit 2, the HDR painterly processing unit 3, the signal processing unit 4, the encoding processing unit 5, and the output unit 6 via the bus 8.

The signal processing unit 2 inputs a proper frame 101, an under frame 102, a proper frame 103, and an over frame 104 to the HDR painterly processing unit 3 via the input terminals 301, 302, 303, and 304. The proper frame 101 is supplied to the WB coefficient calculation unit 305. The under frame 102 is supplied to the development unit 307. The proper frame 103 is supplied to the WB coefficient calculation unit 306 and the development unit 308. The over frame 104 is supplied to the development unit 309. The WB coefficient calculation unit 305 calculates a WB coefficient based on the input proper frame 101 and supplies the WB coefficient to the development unit 307. Similarly, the WB coefficient calculation unit 306 calculates a WB coefficient based on the input proper frame 103 and supplies the WB coefficient to the development units 308 and 309.

The development unit 307 develops the under frame 102 based on the input WB coefficient and supplies the developed frame to the combining unit 310. The development unit 308 develops the proper frame 103 based on the input WB coefficient and supplies the developed frame to the combining unit 310. The development unit 309 develops the over frame 104 based on the input WB coefficient and supplies the developed frame to the combining unit 311.

The combining unit 310 combines the developed under frame 102 and the developed proper frame 103 and supplies the combined frame as a first combined frame to the combining unit 311. The combining unit 311 combines the first combined frame and the developed over frame 104 and supplies the combined frame as a second combined frame to the tone correction unit 312.

The tone correction unit 312 performs tone correction on the second combined frame and supplies the result as a tone curve corrected image to the local contrast correction unit 313. The local contrast correction unit 313 performs local contrast correction on the image data and output the result as an output image to the output terminal 314.

Processing by the HDR painterly processing unit 3 in the camera system configured as described above is described in more detail below.

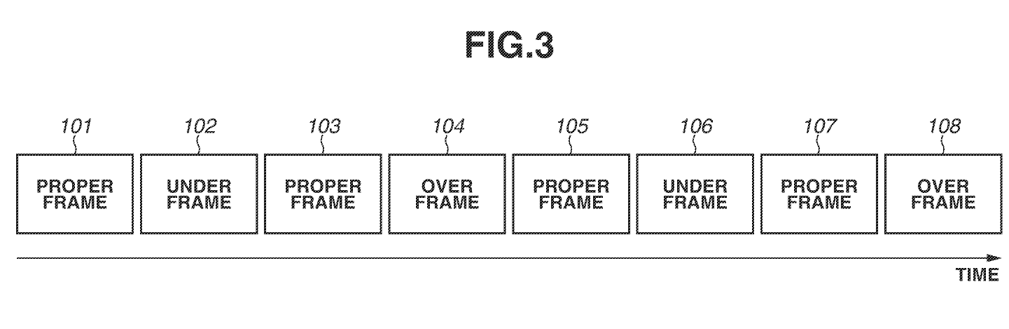

FIG. 3 illustrates an image capturing order according to the present exemplary embodiment. FIG. 3 illustrates that the proper frame 101, the under frame 102, the proper frame 103, and the over frame 104 are captured in this order in time series, and one frame is generated by combining these four frames as a combining frame group. Further, a proper frame 105, an under frame 106, a proper frame 107, and an over frame 108 are successively input as a combining frame group to generate next one frame. Here, a case is described as an example in which the proper frame 101, the under frame 102, the proper frame 103, and the over frame 104 are input.

The proper frame 101, the under frame 102, the proper frame 103, and the over frame 104 are respectively input from the input terminals 301, 302, 303, and 304 in a successive manner by frame unit. For the sake of description, an exposure difference of the proper frame and the under frame and an exposure difference of the proper frame and the over frame are respectively, for example, two stages based on a difference in the ISO sensitivity.

The WB coefficient calculation unit 305 performs processing for whitening white, specifically, calculates a gain (equivalent to the WB coefficient) for making signal values of red, green and blue (R, G, and B) in an area to be white the same using information of the input proper frame 101. The WB coefficient calculation unit 306 performs processing equivalent to that of the WB coefficient calculation unit 305 using information of the proper frame 103.

Generally, it is desirable to calculate the WB coefficient using a frame near a proper exposure.

Therefore, according to the present exemplary embodiment, a proper frame is captured every other frame, a WB coefficient is calculated using the information of the proper frame, and the WB coefficient is applied to the proper frame used for calculating the WB coefficient and another frame than the immediately before proper frame. The proper frame is thus periodically inserted, and accordingly a temporal distance between a frame used for calculating the WB coefficient and a frame being applied with the WB coefficient can be closer, and white balance processing can be highly accurately performed. In addition, the proper frame is periodically inserted, and thus the WB coefficient can be continuously calculated, so that continuity of the processing which is essential for a moving image can be secured.

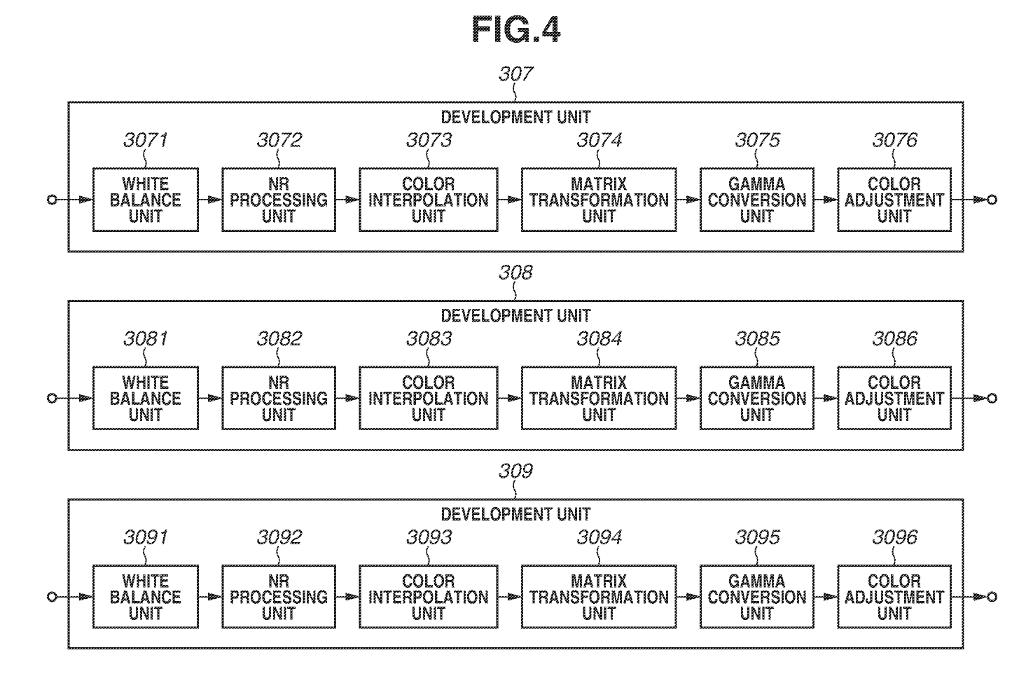

The development units 307, 308, and 309 respectively perform development processing on the under frame 102, the proper frame 103, and the over frame 104. FIG. 4 is a block diagram illustrating the development units 307, 308, and 309. Regarding the outline of processing, most parts of the processing are common in the development units 307, 308, and 309, so that the common parts are described using the development unit 307.

A white balance unit 3071 performs processing for whitening white using the input WB coefficient. A noise reduction (NR) processing unit 3072 reduces noise which is not derived from an object image in an input image but caused by the sensor and the like. A color interpolation unit 3073 generates a color image in which all pixels completely include R, G, and B color information pieces by interpolating a color mosaic image. The generated color image is processed via a matrix transformation unit 3074 and a gamma conversion unit 3075, and accordingly a basic color image is generated. Subsequently, a color adjustment unit 3076 performs processing namely image correction such as, chroma enhancement, hue correction, and edge enhancement on the color image for improving a visual quality of the image.

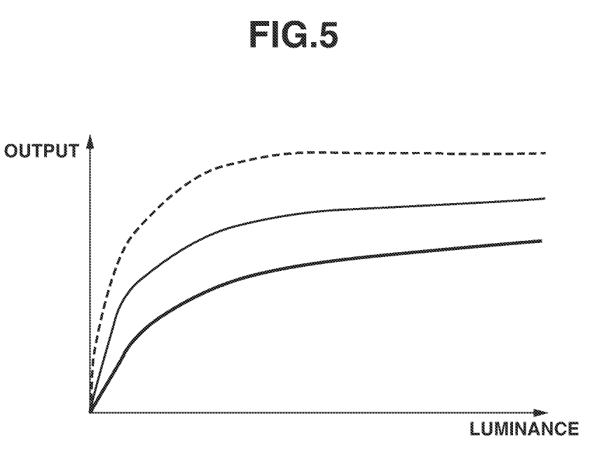

According to the present exemplary embodiment, gains are applied to image signals captured in different exposures in advance to equalize luminance levels therebetween. A gain is required to be set so as not to cause overexposure or underexposure, thus not a uniform gain but a gamma corresponding to an exposure value as illustrated in FIG. 5 is used. In FIG. 5, a solid line, a dotted line, and a thick line respectively represent examples of a gamma for a proper frame, a gamma for an under frame, and a gamma for an over frame. These gammas are used, and the gamma conversion unit 3075 applies the gamma for the under frame, a gamma conversion unit 3085 applies the gamma for the proper frame, and a gamma conversion unit 3095 applies the gamma for the over frame.

As can be seen from gamma characteristics illustrated in FIG. 5, the under frame is applied with the gain larger than the gain applied to the proper frame, and thus there is a concern that noise is increased in the under frame after development compared to the proper frame. In addition, the proper frame is applied with the gain larger than the gain applied to the over frame, and thus there is a concern that noise is increased in the proper frame after development compared to the over frame. Thus, the NR processing unit 3072 performs NR stronger than that of a NR processing unit 3082, and the NR processing unit 3082 performs NR stronger than that of a NR processing unit 3092, so that noise amounts of the proper frame, the under frame, and the over frame after development are equalized. Thus, the NR processing can reduce a feeling of strangeness caused by differences among images of the proper frame, the under frame, and the over frame after the HDR composition. As specific methods for noise reduction, there are various methods including a general method such as smoothing process using an appropriate kernel size and a method using a filter such as an ϵ filter and an edge-preserving bilateral filter, however, an appropriate method may be used in consideration of a balance in a processing speed of the system and a resource such as a memory.

Regarding the above-described development processing, the development units 307, 308, and 309 are described, however, block configurations are the same, so that one single development unit may be used in common by switching parameters used in the development according to an input of the proper frame, the under frame, or the over frame.

The combining unit 310 calculates a composition ratio of the under frame 102 using a luminance composition ratio to be calculated in response to luminance of the under frame 102 and a luminance difference composition ratio to be calculated in response to a difference value between the under frame 102 and the proper frame 103. Further, the combining unit 310 combines the under frame 102 and the proper frame 103 based on the calculated composition ratio and outputs the combined frame as the first combined frame.

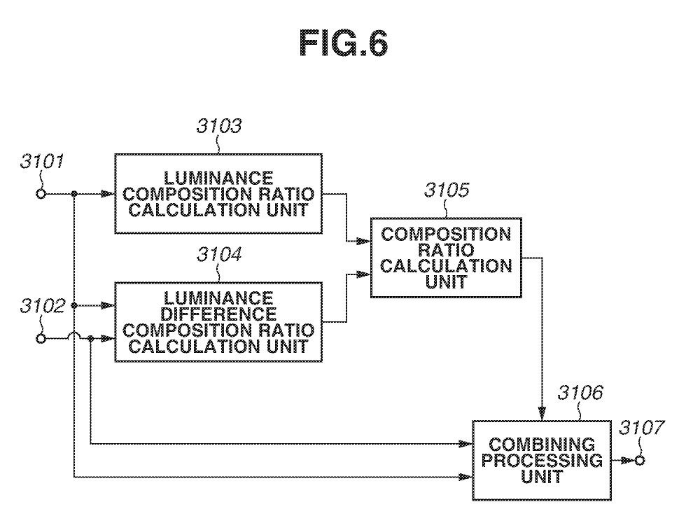

FIG. 6 is a block diagram illustrating the combining unit 310. The under frame 102 is input from an input terminal 3101 and supplied to a luminance composition ratio calculation unit 3103, a luminance difference composition ratio calculation unit 3104, and a combining processing unit 3106. The proper frame 103 is input from an input terminal 3102 and supplied to the luminance difference composition ratio calculation unit 3104 and the combining processing unit 3106.

The luminance composition ratio calculation unit 3103 calculates the luminance composition ratio in response to the luminance of the under frame 102 and supplies the luminance composition ratio to a composition ratio calculation unit 3105. The luminance difference composition ratio calculation unit 3104 calculates the luminance difference composition ratio in response to a luminance difference between the under frame 102 and the proper frame 103 and supplies the luminance difference composition ratio to the composition ratio calculation unit 3105. The composition ratio calculation unit 3105 supplies, for each area, one having a larger value of the luminance composition ratio and the luminance difference composition ratio as a final composition ratio to the combining processing unit 3106. The combining processing unit 3106 combines the proper frame 103 and the under frame 102 based on the final composition ratio and outputs the first combined frame from an output terminal 3107.

The processing is described in more detail below.

First, the luminance composition ratio calculation unit 3103 is described.

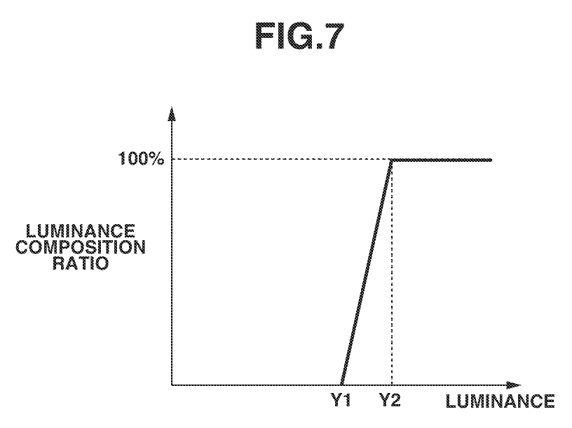

The luminance composition ratio calculation unit 3103 calculates the luminance composition ratio of the under frame 102 with respect to the luminance of the under frame 102. FIG. 7 is an example of a graph for calculating the luminance composition ratio. The processing is described below with reference to FIG. 7. The luminance composition ratio is calculated for each area in response to the luminance of the under frame 102. FIG. 7 represents that the proper frame 103 is used in an area darker than a luminance composition threshold value Y1, and the under frame 102 is used in an area brighter than a luminance composition threshold value Y2 to obtain an HDR composition image. In addition, in an intermediate area in boundaries Y1 to Y2 near the luminance composition threshold values, the composition ratio is gradually changed to smooth switching of images.

Next, the luminance difference composition ratio calculation unit 3104 is described.

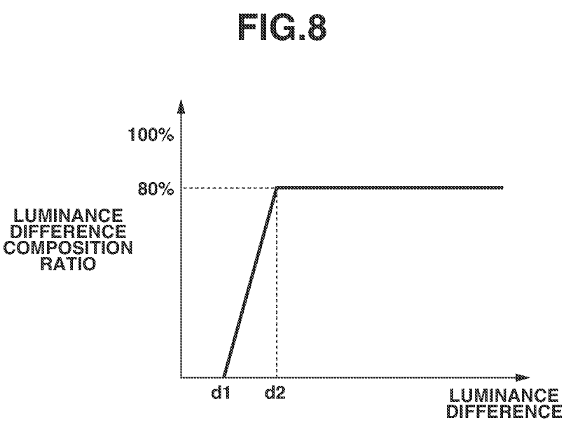

The luminance difference composition ratio calculation unit 3104 calculates the luminance difference composition ratio of the under frame 102 with respect to the luminance difference between the under frame 102 and the proper frame 103. FIG. 8 is an example of a graph for calculating the luminance difference composition ratio. The processing is described below with reference to FIG. 8. The luminance difference composition ratio is calculated for each area in response to the luminance difference between the under frame 102 and the proper frame 103. FIG. 8 represents that the proper frame 103 is used in an area of which the luminance difference is smaller than a luminance difference composition threshold value d1, and the under frame 102 is used in an area of which the luminance difference is larger than a luminance difference composition threshold value d2. In addition, in an intermediate area in boundaries d1 to d2 near the luminance difference composition threshold values, the composition ratio is gradually changed to smooth switching of images.

Next, the composition ratio calculation unit 3105 is described.

The composition ratio calculation unit 3105 calculates the final composition ratio using the luminance composition ratio and the luminance difference composition ratio. In this regard, one having a larger value of the luminance composition ratio and the luminance difference composition ratio is calculated as the final composition ratio for each pixel.

Finally, the combining processing unit 3106 calculates combined image data of the first combined frame using the calculated final composition ratio based on a following formula.

FI1=MI1*(1−fg1)+UI1*fg1 (formula 1)

Each term in the formula is as follows.
fg1: a composition ratio
FI1: image data of the first combined frame
UI1: image data of the under frame 102
MI1: image data of the proper frame 103

The combining unit 311 calculates the composition ratio of the over frame 104 using the luminance composition ratio calculated in response to luminance of the over frame 104 and the luminance difference composition ratio calculated in response to a difference value between the over frame 104 and the first combined frame. Further, the combining unit 311 combines the over frame 104 and the first combined frame based on the calculated composition ratio and outputs the combined frame as the second combined frame.

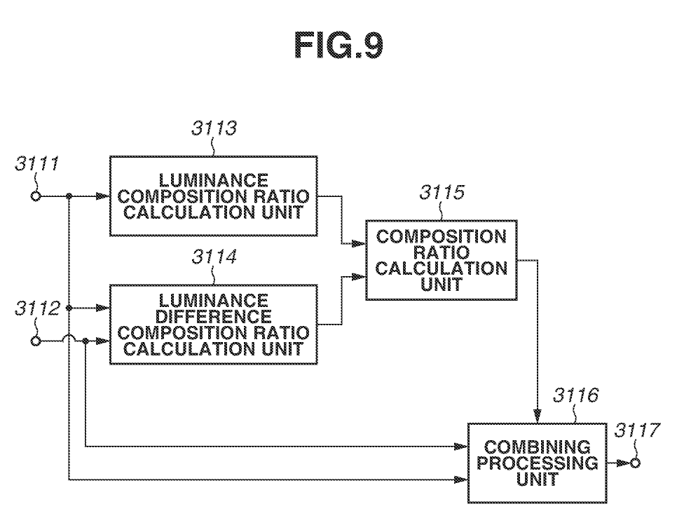

FIG. 9 is a block diagram illustrating the combining unit 311. The over frame 104 is input from an input terminal 3111 and supplied to a luminance composition ratio calculation unit 3113, a luminance difference composition ratio calculation unit 3114, and a combining processing unit 3116. The first combined frame is input from an input terminal 3112 and supplied to the luminance difference composition ratio calculation unit 3114 and the combining processing unit 3116.

The luminance composition ratio calculation unit 3113 calculates the luminance composition ratio in response to the luminance of the over frame 104 and supplies the luminance composition ratio to a composition ratio calculation unit 3115. The luminance difference composition ratio calculation unit 3114 calculates the luminance difference composition ratio in response to the luminance difference between the over frame 104 and the first combined frame and supplies the luminance difference composition ratio to the composition ratio calculation unit 3115. The composition ratio calculation unit 3115 supplies, for each area, one having a larger value of the luminance composition ratio and the luminance difference composition ratio as the final composition ratio to the combining processing unit 3116. The combining processing unit 3116 combines the first combined frame and the over frame 104 based on the final composition ratio and outputs the combined frame as the combined image data (the second combined frame) from an output terminal 3117.

The processing is described in more detail below.

First, the luminance composition ratio calculation unit 3113 is described.

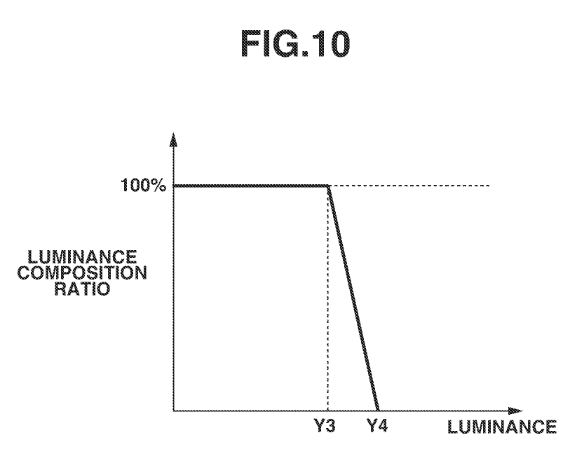

The luminance composition ratio calculation unit 3113 calculates the luminance composition ratio of the over frame 104 with respect to the luminance of the over frame 104. FIG. 10 is an example of a graph for calculating the luminance composition ratio. The processing is described below with reference to FIG. 10. The luminance composition ratio is calculated for each area in response to the luminance of the over frame 104. FIG. 10 represents that the over frame 104 is used in an area darker than a luminance composition threshold value Y3, and the first combined frame is used in an area brighter than a luminance composition threshold value Y4 to obtain the HDR composition image. In addition, in an intermediate area in boundaries Y3 to Y4 near the luminance composition threshold values, the composition ratio is gradually changed to smooth switching of images.

Next, the luminance difference composition ratio calculation unit 3114 is described.

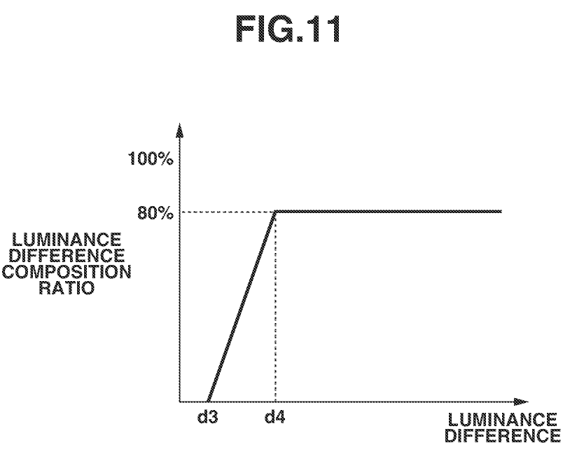

The luminance difference composition ratio calculation unit 3114 calculates the luminance difference composition ratio of the over frame 104 with respect to the luminance difference between the over frame 104 and the first combined frame. FIG. 11 is an example of a graph for calculating the luminance difference composition ratio. The processing is described below with reference to FIG. 11. The luminance difference composition ratio is calculated for each area in response to the luminance difference between the over frame 104 and the first combined frame. FIG. 11 represents that the first combined frame is used in an area of which the luminance difference is smaller than a luminance difference composition threshold value d3, and the over frame 104 is used in an area of which the luminance difference is larger than a luminance difference composition threshold value d4. In addition, in an intermediate area in boundaries d3 to d4 near the luminance difference composition threshold values, the composition ratio is gradually changed to smooth switching of images.

Next, the composition ratio calculation unit 3115 is described.

The composition ratio calculation unit 3115 calculates the final composition ratio using the luminance composition ratio and the luminance difference composition ratio. In this regard, one having a larger value of the luminance composition ratio and the luminance difference composition ratio is calculated as the final composition ratio.

Finally, the combining processing unit 3116 calculates combined image data of the second combined frame using the calculated final composition ratio based on a following formula.

FI2=FI1*(1−fg2)+OI1*fg2 (formula 2)

Each term in the formula is as follows.
fg2: a composition ratio
FI2: image data of the second combined frame (the combined image data)
OI1: image data of the over frame 104
FI1: image data of the first combined frame

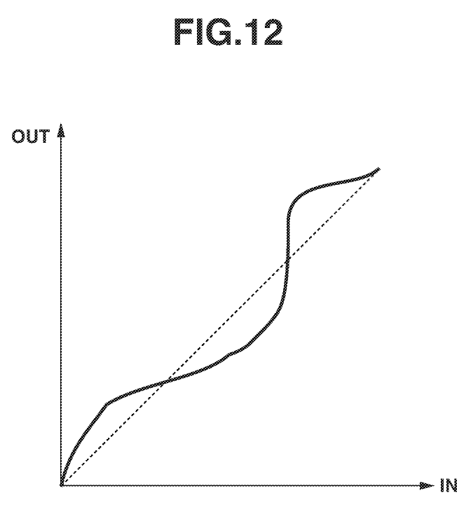

The tone correction unit 312 corrects a tone curve using a lookup table (LUT) with respect to the combined image data. FIG. 12 illustrates an example of a tone curve of an LUT, in which an abscissa axis represents input luminance, and an ordinate axis represents output luminance. As seen in FIG. 12, contrast is enhanced in a dark portion and a bright portion and reduced in an intermediate luminance portion, and thus an effect of looking the image as a painting can be exerted. The image thus subjected to the combined image data tone curve correction is output as a tone curve corrected image to the local contrast correction unit 313.

Regarding the tone curve correction, processing for enhancing the contrast of the dark portion and the bright portion is performed as illustrated in FIG. 12. However, when no gradation remains in the dark portion and the bright portion, an enhancement effect is less how much the contrast enhancement processing is added. According to the present exemplary embodiment, the tone curve correction is performed on an image which is obtained by the HDR composition using the three types of exposures and in which gradation remains in the dark portion and the bright portion, so that the contrast enhancement effect can be more greatly exerted compared to, for example, an image obtained by the HDR composition using two types of exposures.

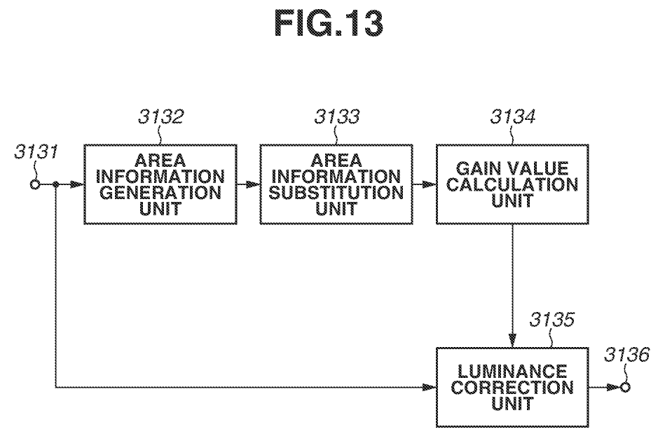

The local contrast correction unit 313 performs processing for generating a halo near an edge having a large difference in brightness and darkness. FIG. 13 is a block diagram illustrating the local contrast correction unit 313.

The tone curve corrected image 113 is input from an input terminal 3131 and supplied to an area information generation unit 3132 and a luminance correction unit 3135. The area information generation unit 3132 divides the image into areas in block unit, calculates an average value of each area, and supplies the average value as a representative value of each area to an area information substitution unit 3133. The area information substitution unit 3133 converts the representative value of each area into a gain value using a gain table and supplies the gain value to a gain value calculation unit 3134. The gain value calculation unit 3134 converts the gain value of each area into a gain value of each pixel and supplies the converted gain value to the luminance correction unit 3135. The luminance correction unit 3135 calculates a luminance corrected image 114 (not illustrated) based on the tone curve corrected image 113 and the gain value of each pixel and outputs the luminance corrected image 114 from an output terminal 3136.

Next, the local contrast correction unit 313 is described in more detail.

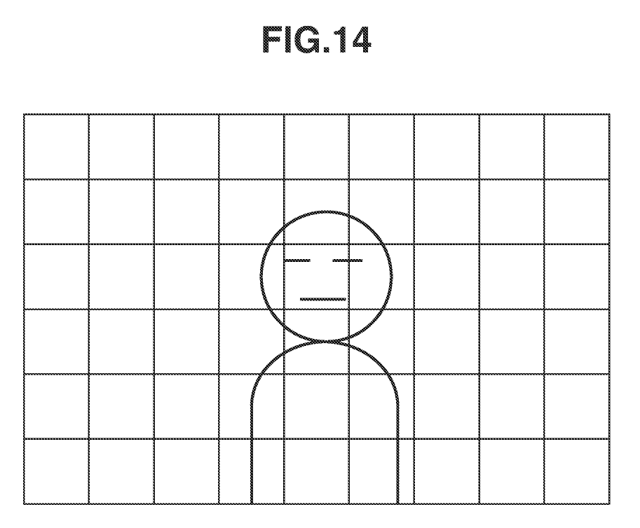

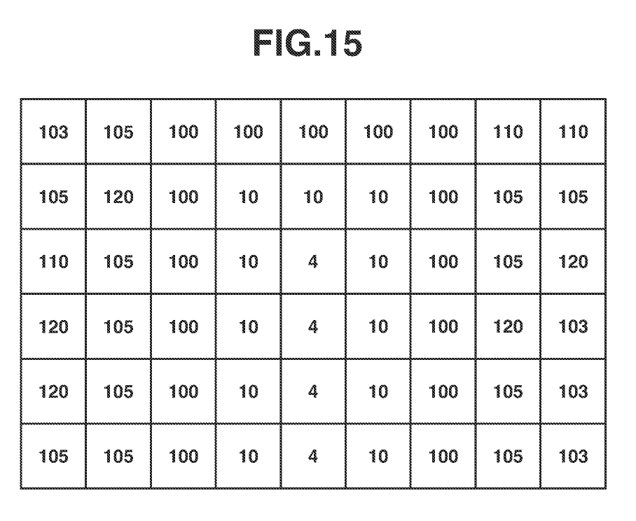

The area information generation unit 3132 divides the input tone curve corrected image 113 into areas. Fig. illustrates an example when an image is divided into nine in a horizontal direction and into six in a vertical direction. According to the present exemplary embodiment, an image is divided into rectangular shapes, however, an image can be divided into arbitrary shapes including polygonal shapes such as triangle shapes and hexagonal shapes. Further, an average value of luminance values of all pixels included in the area is calculated for each divided area as a representative luminance value of the area. FIG. 15 illustrates an example of a representative luminance value of each area corresponding to FIG. 14. According to the present exemplary embodiment, the representative value of the area is the average value of the luminance, however, an average value of any of the RGB values may be regarded as the representative value of the area.

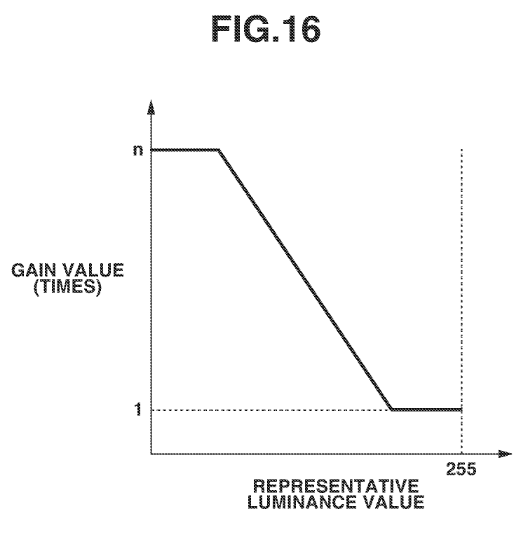

The area information substitution unit 3133 replaces the representative luminance value of each area with the gain value. For example, the representative luminance value can be replaced with the gain value by referring to a gain table stored in advance. FIG. 16 illustrates an example of a gain table characteristic according to the present exemplary embodiment. The gain table characteristic is adjusted, and thus intensity of the halo generated in the image output from the luminance correction unit 3135 can be changed. For example, when the halo to be generated is strengthened, a difference may be increased between a gain to an area of which the luminance average value is low and a gain to an area of which the luminance average value is high.

The gain value calculation unit 3134 calculates the gain value of each pixel using the gain value of each area as an input. For example, the gain of each pixel is calculated based on a principle described below. First, a distance from a pixel for calculating a gain (a target pixel) to a center or a gravity center of a plurality of areas near an area including the target pixel is calculated, and four areas are selected in order of shortness of the distance. Subsequently, the gain value of each pixel is calculated by performing two-dimensional linear interpolation so that the gain value of each of the four selected areas is applied with a larger weight as the distance is smaller between the target pixel and the center/gravity center of the area. There is no limitation on methods for calculating the gain value of each pixel based on the gain value of each area, and it is needless to say that other methods may be used.

If an original image having 1920*1080 pixels is divided into blocks of 192 vertical pixels by 108 horizontal pixels, 10*10 pixels (an image constituted of the representative luminance value) are output from the area information generation unit 3132. When an image in which each pixel value of the image (the representative luminance value) is replaced with the gain value by the area information substitution unit 3133 is enlarged by the linear interpolation to the number of pixels of the original image, each pixel value after the enlargement will be the gain value of the pixel corresponding to the original image.

The luminance correction unit 3135 performs luminance correction on each pixel by applying the gain value calculated for each pixel to the tone curve corrected image 113 and outputs the result to the output terminal 3136. The luminance correction is realized by following formulae.

Rout=Gain*Rin (formula 3)

Gout=Gain*Gin (formula 4)

Bout=Gain*Bin (formula 5)

Rout, Gout, and Bout respectively represent the RGB pixel values after the luminance correction, Rin, Gin, and Bin respectively represent the RGB pixel values of the tone curve corrected image 113, and Gain represents the gain value of each pixel.

The local contrast correction is processing for applying a larger gain to a dark portion in an image as illustrated in a gain table in FIG. 16. In this case, if a gradation is not remained in the dark portion, an effect of applying the gain cannot be exerted, and also noise is generated in the dark portion which may greatly deteriorate the image quality in some cases. According to the present exemplary embodiment, the over frame is used in the HDR composition, so that the noise of the dark portion can be suppressed compared to a case when the over frame is not used, and the gradation in the dark portion can be maintained.

Finally, the luminance corrected image is output from the output terminal 314.

As described above, according to the present exemplary embodiment, the HDR image is generated using images of the three types of exposures, namely the proper frame, the under frame, and the over frame, and accordingly an image can be generated in which gradations are remained in a dark portion and a bright portion. The tone curve correction and the local contrast correction for exerting the painterly effect are applied to the thus generated image, so that the higher painterly effect can be realized than a case, for example, when the HDR image is generated using only the proper frame and the under frame. In addition, the WB coefficient is calculated using the proper frame which is inserted every other frame while capturing images of the three types of exposures, so that a time lag in the WB correction other than the proper frame can be reduced, and the WB correction can be realized which is more highly accurate and maintains the continuity essential for a moving image.

The present exemplary embodiment is described using the WB coefficient as the example, however, it is needless to say that the present exemplary embodiment can be applied to processing for performing detection in a proper frame and applying the detection result to an under frame and an over frame, such as processing for performing gradation correction based on a histogram of an image.

According to a second exemplary embodiment, development is performed without matching brightness between frames different in exposures so as to increase a painterly effect more than that in the first exemplary embodiment. According to the first exemplary embodiment, brightness between different exposures is equalized using the gamma, and thus moving object detection can be performed by calculating a difference between different exposures, however, the same cannot be applied to the present exemplary embodiment. Thus, according to the present exemplary embodiment, a method for detecting a moving object is described in which a difference value is calculated between proper frames of which brightness is matched with each other in five frames including a proper frame, an under frame, a proper frame, an over frame, and further a proper frame captured after the over frame in time series for the moving object detection. In addition, an effect by tone correction after the HDR composition and processing for generating a halo at an edge portion having a large density difference are described as an example of the painterly effect in addition to a tone correction effect by the gamma.

FIG. 1 is a block diagram illustrating an example of a camera system according to the second exemplary embodiment. The configuration and outline of processing in FIG. 1 are the same as those according to the first exemplary embodiment, and thus the descriptions thereof are omitted.

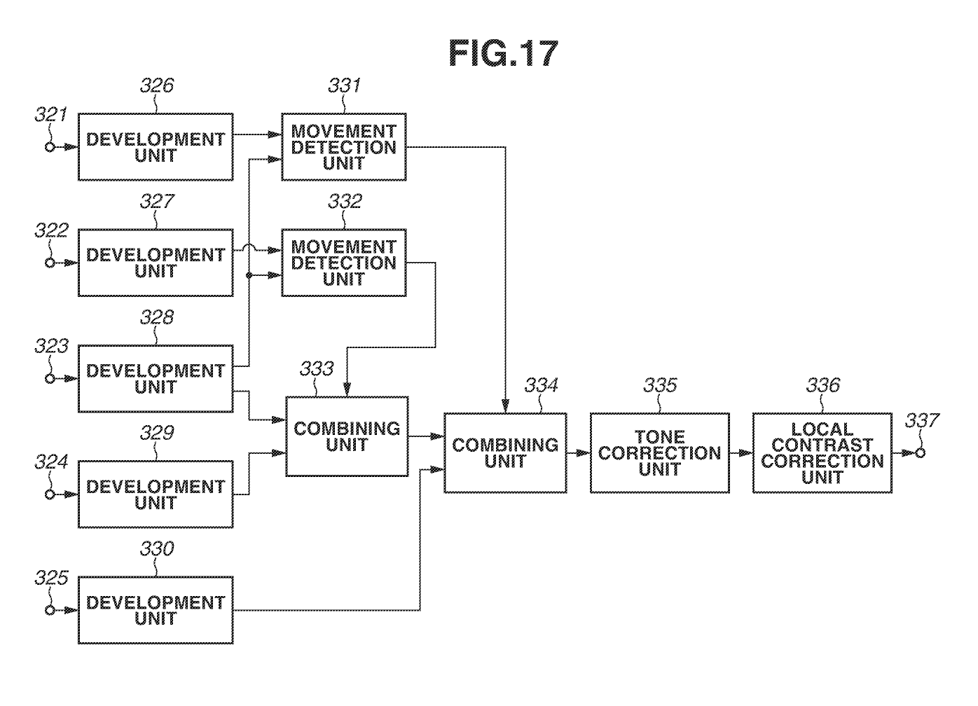

FIG. 17 is a block diagram illustrating an example of the HDR painterly processing unit 3.

The HDR painterly processing unit 3 illustrated in FIG. 17 includes input terminals 321, 322, 323, 324, and 325, development units 326, 327, 328, 329, and 330, movement detection units 331 and 332, combining units 333 and 334, a tone correction unit 335, a local contrast correction unit 336, and an output terminal 337.

A processing outline of the HDR painterly processing unit 3 including the above-described configuration is described below.

The proper frame 105, the proper frame 101, the proper frame 103, the under frame 102, and the over frame 104 are input from the signal processing unit 2 via the input terminals 321, 322, 323, 324, and 325 and respectively supplied to the development units 326, 327, 328, 329, and 330.

The development units 326, 327, 328, 329, and 330 perform development processing on the respective input images. The development unit 326 supplies the developed image to the movement detection unit 331. The development unit 327 supplies the developed image to the movement detection unit 332. The development unit 328 supplies the developed image to the movement detection units 331 and 332 and the combining unit 333. The development unit 329 supplies the developed image to the combining unit 333. The development unit 330 supplies the developed image to the combining unit 334. The movement detection unit 331 performs movement detection based on the developed proper frames 105 and 103 and supplied the movement detection result to the combining unit 334.

The movement detection unit 332 performs movement detection based on the developed proper frames 101 and 103 and supplies the movement detection result to the combining unit 333. The combining unit 333 combines the developed proper frame 103 and the developed under frame 102 based on the movement detection result and supplies the combined frame as a third combined frame to the combining unit 334. The combining unit 334 combines the developed over frame 104 and the third combined frame based on the movement detection result and supplies the combined frame as a fourth combined frame to the tone correction unit 335.

The tone correction unit 335 performs tone correction processing on the fourth combined frame and supplies the result as a tone corrected frame to the local contrast correction unit 336. The local contrast correction unit 336 performs local contrast correction processing on the tone corrected frame and outputs the result as a local contrast correction frame from the output terminal 337.

Processing by the HDR painterly processing unit 3 in the camera system configured as described above is described in more detail below.

FIG. 3 illustrates an image capturing order according to the present exemplary embodiment. The image capturing order is FIG. 3 is the same as that according to the first exemplary embodiment, and thus the description thereof is omitted. However, according to the present exemplary embodiment, a case is described as an example in which the proper frame 105, the proper frame 101, the proper frame 103, the under frame 102, and the over frame 104 are input as described above.

The proper frame 105, the proper frame 101, the proper frame 103, the under frame 102, and the over frame 104 are respectively input from the input terminals 321, 322, 323, 324, and 325 by frame unit. For the sake of description, an exposure difference of the proper frame and the under frame and an exposure difference of the proper frame and the over frame are respectively, for example, two stages based on a difference in the ISO sensitivity.

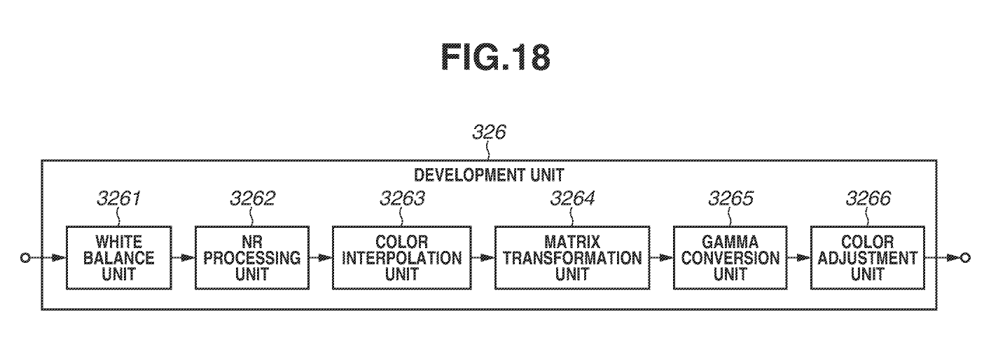

The development units 326, 327, 328, 329 and 330 respectively perform the development processing on the proper frame 105, the proper frame 101, the proper frame 103, the under frame 102, and the over frame 104. The block configurations are common in the development units 326, 327, 328, 329, and 330, and thus the common portion is described using the development unit 326 as a representative, and different portions of processing are described using the respective blocks. FIG. 18 is a block diagram illustrating the development unit 326.

A white balance unit 3261 performs processing for whitening white, specifically, calculates a gain (equivalent to the WB coefficient) for making signal values of R, G, and B in an area to be white the same using respectively input frame information. A NR processing unit 3262 reduces noise which is not derived from an object image in an input image but caused by the sensor and the like. A color interpolation unit 3263 generates a color image in which all pixels completely include R, G, and B color information pieces by interpolating a color mosaic image. The generated color image is processed via a matrix transformation unit 3264 and a gamma conversion unit 3265, and accordingly a basic color image is generated. Subsequently, a color adjustment unit 3266 performs processing namely image correction such as, chroma enhancement, hue correction, and edge enhancement on the color image for improving a visual quality of the image.

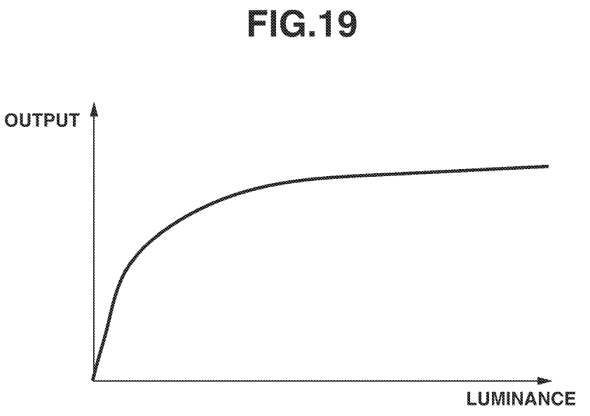

According to the present exemplary embodiment, the same gain is applied to image signals captured in different exposures in advance. A gain is required to be set so as not to cause overexposure or underexposure, thus not a uniform gain but a gamma as illustrated in FIG. 19 is used. According to the present exemplary embodiment, processing for brightening a dark portion and darkening a bright portion is performed to more enhance the painterly effect. As a final target, it is desirable to combine images so that the under frame, the over frame, and the proper frame are respectively assigned to a bright portion, a dark portion, and an intermediate portion. Thus, when brightness of the proper frame is used as a reference, the under frame is applied with a gamma for darkening compared to the proper frame, and the over frame is applied with a gamma for brightening compared to the proper frame. In other words, the same gamma is applied to each frame, and accordingly an effect of brightening the dark portion and darkening the bright portion in the final combined image can be exerted. The gamma conversion units 3265, 3275, 3285, 3295, and 3305 perform the above-described gamma processing on the respective frames.

The development processing is described above on the assumption that the development units 326, 327, 328, 329, and 330 physically exist, however, the block configurations are the same, so that one single development unit may be used in common by switching parameters used in the development according to an input of the proper frame, the under frame, or the over frame.

The movement detection unit 331 detects a movement between the developed proper frames 105 and 103. Specifically, the movement detection unit 331 calculates a difference value of each pixel in the proper frame 105 and in the proper frame 103 and outputs the difference value of each pixel as a first movement detection frame. Similarly, the movement detection unit 332 calculates a difference value of each pixel in the proper frame 101 and that in the proper frame 103 to detect a movement between the developed proper frames 101 and 103 and outputs the difference value of each pixel as a second movement detection frame.

The combining unit 333 calculates a composition ratio of the under frame 102 using a luminance composition ratio to be calculated in response to luminance of the developed under frame 102 and a luminance difference composition ratio to be calculated in response to the first movement detection frame, Further, the combining unit 333 combines the under frame 102 and the proper frame 103 based on the calculated composition ratio and outputs the combined frame as the third combined frame.

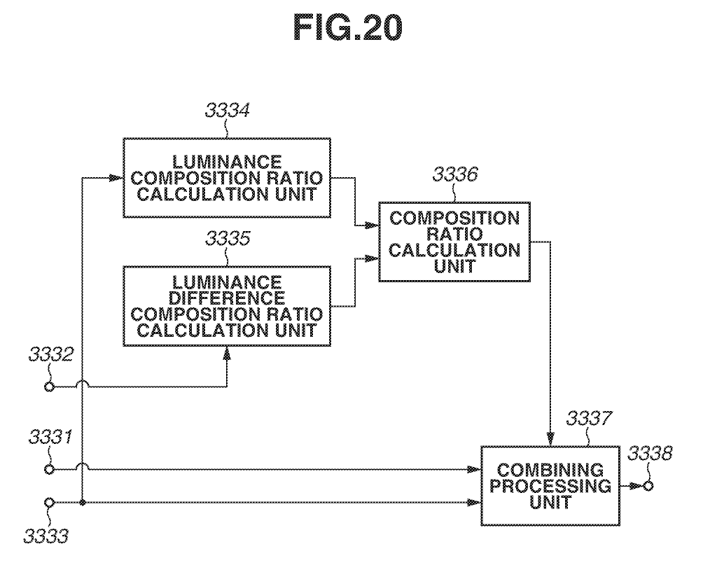

FIG. 20 is a block diagram illustrating the combining unit 333. The developed under frame 102 is input from an input terminal 3331 and supplied to a combining processing unit 3337. The second movement detection frame is input from an input terminal 3332 and supplied to a luminance difference composition ratio calculation unit 3335. The developed proper frame 103 is input from an input terminal 3333 and supplied to a luminance composition ratio calculation unit 3334 and the combining processing unit 3337.

The luminance composition ratio calculation unit 3334 calculates the luminance composition ratio based on luminance of the developed proper frame 103 and supplies the luminance composition ratio to a composition ratio calculation unit 3336. The luminance difference composition ratio calculation unit 3335 calculates the luminance difference composition ratio based on the second movement detection frame and outputs the luminance difference composition ratio to the composition ratio calculation unit 3336. The composition ratio calculation unit 3336 supplies, for each area, one having a larger value of the luminance composition ratio and the luminance difference composition ratio as a final composition ratio to the combining processing unit 3337. The combining processing unit 3337 combines the proper frame 103 and the under frame 102 based on the final composition ratio and outputs the combined frame as a third combined frame from an output terminal 3338.

The processing is described in more detail below.

First, the luminance composition ratio calculation unit 3334 is described.

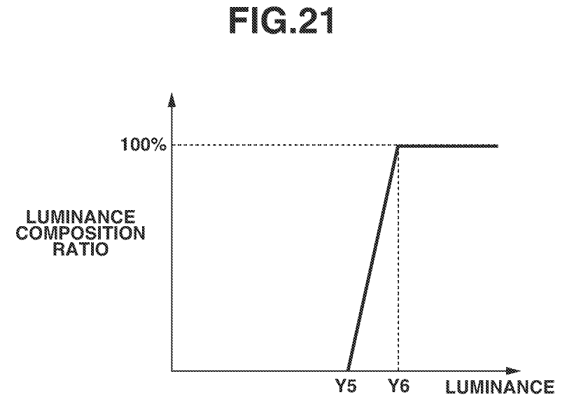

The luminance composition ratio calculation unit 3334 calculates the luminance composition ratio of the under frame 102 using the luminance of the proper frame 103. FIG. 21 is an example of a graph for calculating the luminance composition ratio. The processing is described below with reference to FIG. 21. The luminance composition ratio is calculated for each area in response to the luminance of the proper frame 103. FIG. 21 represents that the proper frame 103 is used in an area darker than a luminance composition threshold value Y5, and the under frame 102 is used in an area brighter than a luminance composition threshold value Y6 to obtain an HDR composition image. In addition, in an intermediate area in boundaries Y5 to Y6 near the luminance composition threshold values, the composition ratio is gradually changed to smooth switching of images.

Next, the luminance difference composition ratio calculation unit 3335 is described.

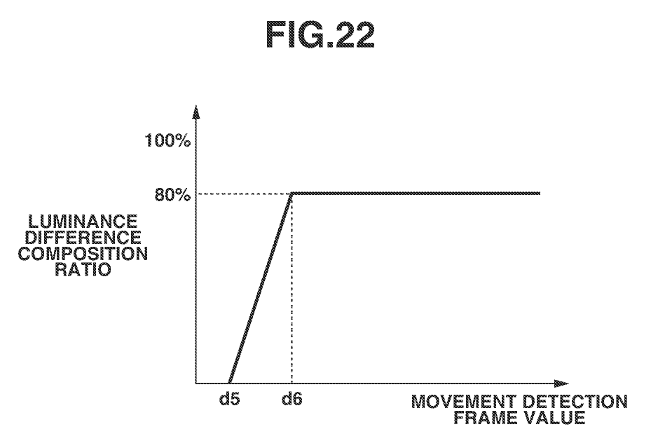

The luminance difference composition ratio calculation unit 3335 calculates the luminance difference composition ratio of the under frame 102 using the second movement detection frame. FIG. 22 is an example of a graph for calculating the luminance difference composition ratio. The processing is described below with reference to FIG. 22. The luminance difference composition ratio is calculated for each area using the second movement detection frame. FIG. 22 represents that the proper frame 103 is used in an area in which a value of the movement detection frame is less than a luminance difference composition threshold value d5, and the under frame 102 is used in an area in which a value of the movement detection frame is greater than a luminance difference composition threshold value d6. In addition, in an intermediate area in boundaries d5 to d6 near the luminance difference composition threshold values, the composition ratio is gradually changed to smooth switching of images.

Next, the composition ratio calculation unit 3336 is described.

The composition ratio calculation unit 3336 calculates the final composition ratio using the luminance composition ratio and the luminance difference composition ratio. In this regard, one having a larger value of the luminance composition ratio and the luminance difference composition ratio is calculated as a final composition ratio fg3 for each pixel.

Finally, the combining processing unit 3337 calculates combined image data of the third combined frame 121 using the calculated final composition ratio based on a following formula.

FI3=MI3*(1−fg3)+UI3*fg3 (formula 6)

Each term in the formula is as follows.
fg3: a composition ratio
FI3: image data of the third combined frame
MI3: image data of the proper frame 103
UI3: image data of the under frame 102

The combining unit 334 calculates the composition ratio of the over frame 104 using the luminance composition ratio to be calculated in response to luminance of the third combined frame and the luminance difference composition ratio to be calculated in response to the first movement detection frame. Further, the combining unit 334 combines the third combined frame and the over frame 104 based on the calculated composition ratio and outputs the combined frame as a fourth combined frame.

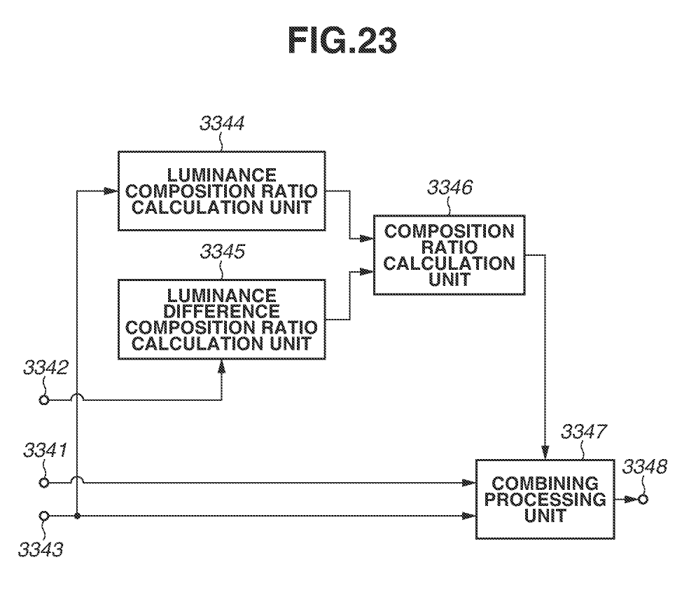

FIG. 23 is a block diagram illustrating the combining unit 334. The developed over frame 104 is input from an input terminal 3341 and supplied to a combining processing unit 3347. The first movement detection frame is input from an input terminal 3342 and supplied to a luminance difference composition ratio calculation unit 3345. The third combined frame is input from an input terminal 3343 and supplied to a luminance composition ratio calculation unit 3344 and the combining processing unit 3347.

The luminance composition ratio calculation unit 3344 calculates the luminance composition ratio based on the luminance of the third combined frame and supplies the luminance composition ratio to a composition ratio calculation unit 3346. The luminance difference composition ratio calculation unit 3345 calculates the luminance difference composition ratio based on the first movement detection frame and outputs the luminance difference composition ratio to the composition ratio calculation unit 3346. The composition ratio calculation unit 3346 supplies, for each area, one having a larger value of the luminance composition ratio and the luminance difference composition ratio as the final composition ratio to the combining processing unit 3347. The combining processing unit 3347 combines the third combined frame and the over frame 104 based on the final composition ratio and outputs the combined frame as the fourth combined frame from an output terminal 3348.

The processing is described in more detail below.

First, the luminance composition ratio calculation unit 3344 is described.

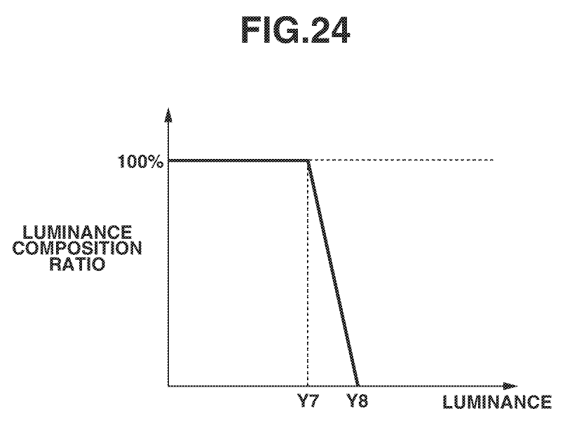

The luminance composition ratio calculation unit 3344 calculates the luminance composition ratio of the over frame 104 using the luminance of the third combined frame. FIG. 24 is an example of a graph for calculating the luminance composition ratio. The processing is described below with reference to FIG. 24. The luminance composition ratio is calculated for each area in response to the luminance of the over frame 104.

FIG. 24 represents that the over frame 104 is used in an area darker than a luminance composition threshold value Y7, and the third combined frame is used in an area brighter than a luminance composition threshold value Y8 to obtain the HDR composition image. In addition, in an intermediate area in boundaries Y7 to Y8 near the luminance composition threshold values, the composition ratio is gradually changed to smooth switching of images.

Next, the luminance difference composition ratio calculation unit 3345 is described.

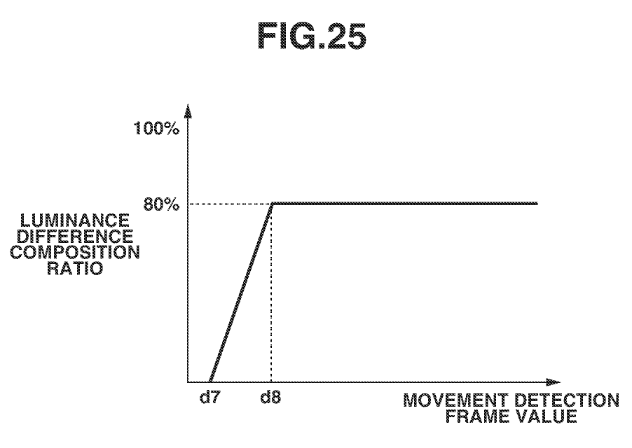

The luminance difference composition ratio calculation unit 3345 calculates the luminance difference composition ratio of the over frame 104 with respect to the first movement detection frame. FIG. 25 is an example of a graph for calculating the luminance difference composition ratio. The processing is described below with reference to FIG. 25. FIG. 25 represents that the third combined frame is used in an area in which a value of the movement detection frame is less than a luminance difference composition threshold value d7, and the over frame 104 is used in an area in which a value of the movement detection frame is greater than a luminance difference composition threshold value d8. In addition, in an intermediate area in boundaries d7 to d8 near the luminance difference composition threshold values, the composition ratio is gradually changed to smooth switching of images.

Next, the composition ratio calculation unit 3346 is described.

The composition ratio calculation unit 3346 calculates the final composition ratio using the luminance composition ratio and the luminance difference composition ratio. In this regard, one having a larger value of the luminance composition ratio and the luminance difference composition ratio is calculated as a final composition ratio fg4 for each pixel.

Finally, the combining processing unit 3347 calculates combined image data of the fourth combined frame using the calculated final composition ratio based on a following formula.

FI4=FI3*(1−fg4)+OI4*fg4 (formula 7)

Each term in the formula is as follows.
fg4: a composition ratio
FI4: image data of the fourth combined frame
OI4: image data of the over frame 104
F13: image data of the third combined frame

The tone correction unit 335 corrects a tone curve using a LUT with respect to the third combined frame. Regarding the tone curve described here, the tone curve used in FIG. 12 according to the first exemplary embodiment may be used to obtain the painterly effect on an image by enhancing contrast of a dark portion and a bright portion and reducing contrast of an intermediate luminance portion than that of the first exemplary embodiment for an effect of the gamma, and the tone curve may be linearized to obtain only an effect of the gamma. The configuration of the tone correction unit 335 is similar to that of the tone correction unit 312 according to the first exemplary embodiment, so that the description thereof is omitted.

Finally, the local contrast correction unit 336 performs processing for generating a halo near an edge having a large difference in brightness and darkness. The processing is also similar to that of the local contrast correction unit 313 according to the first exemplary embodiment, so that the description thereof is omitted.

As described above, the present exemplary embodiment can more enhance the painterly effect by applying the gamma which does not equalize brightness to each frame before the HDR composition in addition to the first exemplary embodiment. Further, the present exemplary embodiment can realize the moving object detection highly accurately by performing the movement detection between the proper frames of which brightness are matched with each other while realizing generation of the image as described above. The present exemplary embodiment is described using the movement detection as the example, however, it is needless to say that the present exemplary embodiment can be realized by processing which can be realized by only frames of which brightness are matched with each other, for example, position alignment processing between frames.

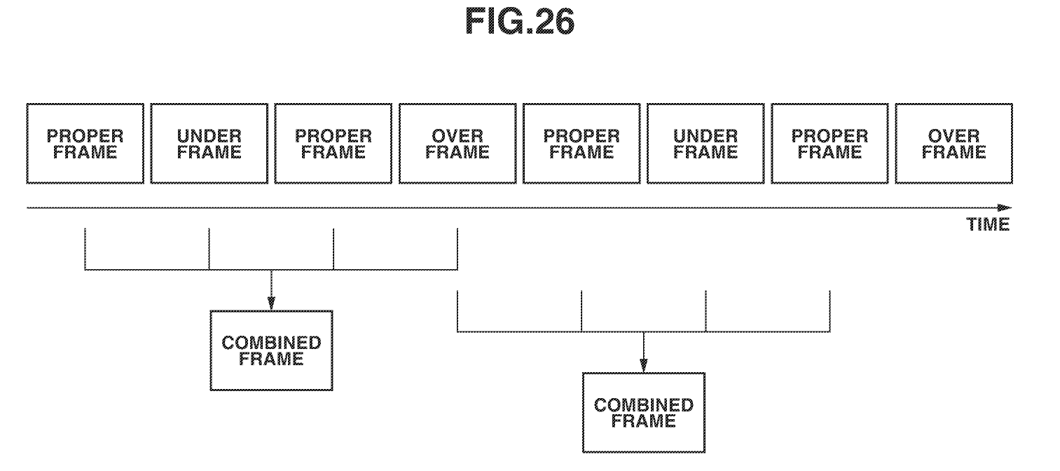

In the method described according to the first and the second exemplary embodiments, a frame rate is reduced lower than an image capturing frame rate, however, the processing can be realized without reducing the frame rate as much as possible by partly overlapping frames to be combined as illustrated in FIG. 26.

The image processing apparatus and the control method thereof according to the above-described first and second exemplary embodiments may be realized by a general-purpose information processing apparatus such as a personal computer and a computer program executed by the information processing apparatus.

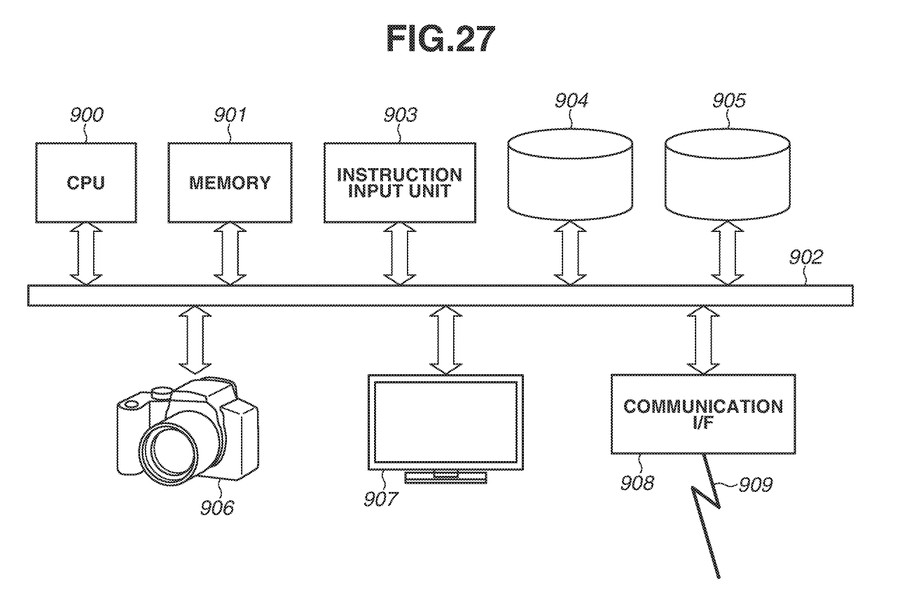

FIG. 27 is a block configuration diagram illustrating an information processing apparatus according to a third exemplary embodiment.

In FIG. 27, a central processing unit (CPU) 900 performs control of an entire apparatus and various types of processing. A memory 901 is constituted of a read-only memory (ROM) storing a basic input output system (BIOS) and a boot program and a random access memory (RAM) used by the CPU 900 as a work area. An instruction input unit 903 is constituted of a keyboard, a pointing device such as a mouse, and various switches. An external storage device 904 (for example, a hard disk device) provides an operating system (OS) necessary for the control of the present apparatus, a computer program according to the first exemplary embodiment, and a storage area necessary for calculation. A storage device 905 accesses a portable storage medium (for example, a Blu-ray disk read-only memory (BD-ROM) and a digital versatile disk read-only memory (DVD-ROM) disk) for storing moving image data. A bus 902 is used to exchange image data between a computer and an external interface.

A digital camera 906 captures an image and also obtains each speed which is an output from each speed sensor. A display 907 outputs a processing result, and a communication circuit 909 is constituted of a local area network (LAN), a public circuit, a wireless circuit, and an airwave. A communication interface 908 transmits and receives image data via the communication circuit 909.

The information processing apparatus including the above-described configuration is described.

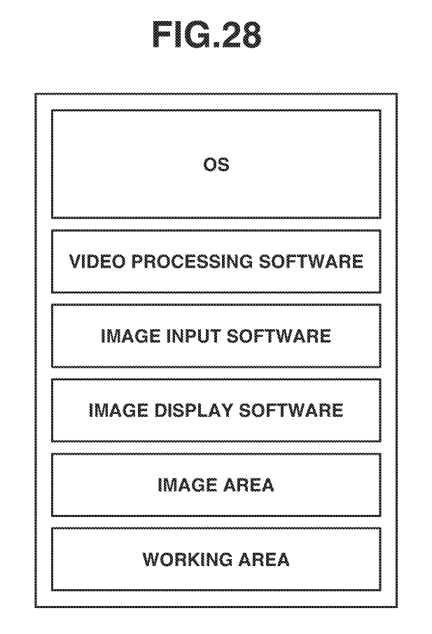

When a power source is input to the apparatus by the instruction input unit 903 before processing, the CPU 900 causes the external storage device 904 to load the OS to the memory 901 (RAM) according to the boot program (stored in the ROM) in the memory 901. Further, an application program is loaded from the external storage device 904 to the memory 901 according to an instruction from a user, and thus the present apparatus functions as the image processing apparatus. FIG. 28 illustrates a storage condition of the memory when the application program is loaded to the memory 901.

The memory 901 stores the OS for controlling the entire apparatus and various types of software and video processing software for performing HDR composition and adding the painterly effect. The memory 901 further stores image input software for controlling the camera 906 to capture a proper frame, an under frame, a proper frame, and an over frame in this order and to input (capture) a frame one by one as a moving image. In addition, the memory 901 includes an image area for storing image data and a working area for storing various parameters.

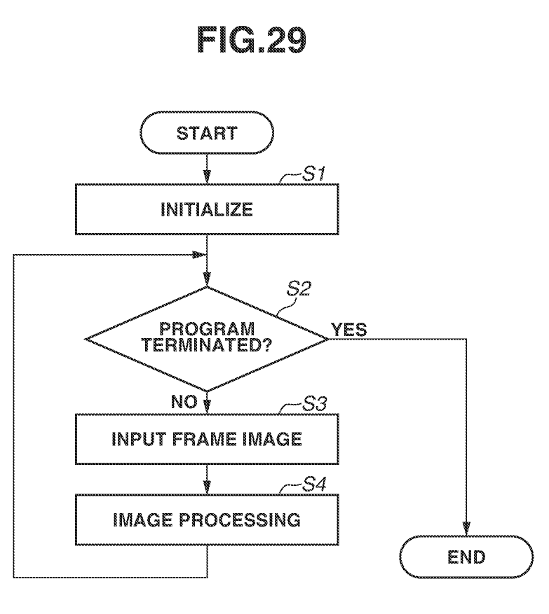

FIG. 29 is a flowchart illustrating video processing by an application executed by the CPU 900.

In step S1, initialization is performed on each unit. In step S2, it is determined whether the program is terminated. The termination is determined based on whether a user inputs a termination instruction from the instruction input unit 903.

In step S3, an image is input to the image area of the memory 901 by frame unit. In step S4, the HDR composition and the painterly effect addition are performed as the image processing, and the processing returns to step S2.

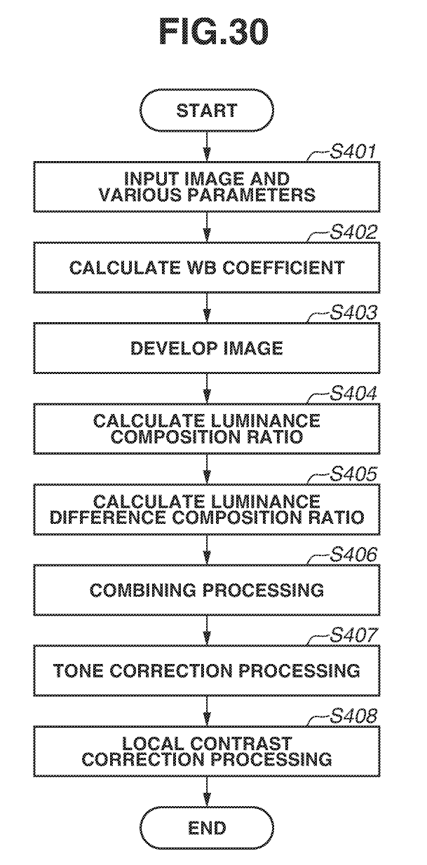

The image processing in step S4 is described in detail using a flowchart in FIG. 30.

In step S401, a proper frame, an under frame, a proper frame, and an over frame which are at least temporally continuous in images stored in the storage device 905 and various parameters are stored in the memory 901. In step S402, the WB coefficient is calculated using the proper frame. In step S403, the proper frame is developed using the WB coefficient calculated using the proper frame itself, and the other frames are developed using the WB coefficient calculated using the proper frame temporally previous thereto. In step S404, the luminance composition ratios are respectively calculated using the under frame and the over frame. In step S405, the luminance difference composition ratios are respectively calculated using the proper frame and the under frame, and the proper frame and the over frame. In step S406, the proper, under, and over frames are combined using the luminance composition ratio and the luminance difference composition ratio. In step S407, the tone correction is performed on the combined frame. Finally, in step S408, the local contrast correction processing is performed, and the calculated image frame is stored in the memory 901.

As described above, the present exemplary embodiment can obtain an effect similar to that of the first exemplary embodiment in an image quality. The computer program is normally stored in a computer-readable storage medium, and the computer program can be executed by setting the computer-readable storage medium in a reading apparatus included in a computer and copying or installing to a system. Accordingly, it is obvious that the above-described computer-readable storage medium is included in the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-073927, filed Apr. 3, 2017, which is hereby incorporated by reference herein in its entirety.

What is claimed is:

1. An image processing apparatus which captures a group of combining frames different in exposures and generates one frame by combining frames, the image processing apparatus comprising:
an image capturing unit configured to capture four frames including a proper frame every other frame and an under frame in one frame and an over frame in a remaining one frame therebetween as a combining frame group;
a development unit configured to develop each frame in the combining frame group;
a combining unit configured to select at least one frame in the combining frame group to combine based on the developed combining frame group; and
a processing unit configured to apply an effect based on the combined combining frame.

2. The image processing apparatus according to claim 1, wherein the combining unit performs combining using at least the under frame and the over frame in the captured frames.

3. The image processing apparatus according to claim 1, wherein the proper frame is used to detect information for performing at least one processing in auto focus, auto exposure, and auto white balance.

4. The image processing apparatus according to claim 1, wherein, in a case where the development unit does not equalize brightness of each of the proper frame, the under frame, and the over frame, the combining unit perform moving object detection in the proper frames.

5. The image processing apparatus according to claim 1, wherein, in a case where the development unit equalizes brightness of each of the proper frame, the under frame, and the over frame, the combining unit perform moving object detection in the proper frame and the under frame or in the proper frame and the over frame.

6. The image processing apparatus according to claim 4, wherein the combining unit performs processing based on a result of the moving object detection.

7. The image processing apparatus according to claim 1, wherein the processing unit performs tone correction and addition of an effect of a halo and includes an area information generation unit configured to control intensity of the effect of the halo and a gain value calculation unit configured to control intensity of the halo.

8. An image capturing apparatus which captures a group of combining frames different in exposures and outputs a moving image in which a combined image obtained by combining the combining frame group is regarded as one frame, the image capturing apparatus comprising:
an image capturing unit configured to capture four frames consisting of the combining frame group, wherein the image capturing unit captures a proper frame every other frame and an under frame in one frame and an over frame in a remaining one frame therebetween.
a development unit configured to develop each frame in the combining frame group;
a combining unit configured to generate a combined image by combining an image developed by the development unit and to output a moving image including the combined image as one frame; and
an obtainment unit configured to obtain image information from the proper frame in the combining frame group,
wherein at least either one of the development unit and the combining unit uses the image information obtained by the obtainment unit for own processing.

9. The image capturing apparatus according to claim 8, wherein the obtainment unit obtains a white balance coefficient as the image information from the proper frame, and the development unit develops each frame in the combining frame group using the white balance coefficient.

10. The image capturing apparatus according to claim 8,
wherein the obtainment unit obtains information regarding a moving object in an image as the image information using the two proper frames, and
wherein the combining unit uses the information regarding the moving object for the combining processing.

11. The image capturing apparatus according to claim 10, wherein the obtainment unit obtains information regarding the moving object in the image based on a difference value of each pixel in the two proper frames.

12. The image capturing apparatus according to claim 8, wherein the combined image is a high dynamic range (HDR) image.
